(19) United States
(12) Patent Application Publication
(10) Pub. No.: US 2025/0362426 A1
(43) Pub. Date: Nov. 27, 2025

(54) METHOD FOR ESTIMATING FORMATION TOPS FOR A PROPOSED DRILLING WELL USING A GRIDDED INTERPOLATION METHOD

(71) Applicant: SAUDI ARABIAN OIL COMPANY, Dhahran (SA)

(72) Inventor: Fatai ANIFOWOSE, Dhahran (SA)

(73) Assignee: SAUDI ARABIAN OIL COMPANY, Dhahran (SA)

(21) Appl. No.: 18/670,483

(22) Filed: May 21, 2024

(51) Int. Cl. G01V 11/00; E21B 41/00; G01V 20/00

(52) U.S. Cl. CPC G01V 11/002; E21B 41/00; G01V 20/00; E21B 2200/20

(57) ABSTRACT

System and methods are disclosed relating to estimating formation tops for a proposed drilling well ahead of its drilling by taking known depths for each formation from offset wells, converting these known depths to a gridded set of points, forming a polygon, and then evaluating the depth of a new point in the polygon by using any of the linear, cubic, Akima, or spline interpolation methods. Performing this for all the formation tops creates a stack of grids, and the stacked grids are solved recursively to generate a complete formation tops profile for a proposed drilling well.

### FIELD OF THE DISCLOSURE

This disclosure relates generally to estimating formation tops for a proposed drilling well, and more specifically, utilizing a stacked and gridded interpolation method to estimate the formation tops of a proposed well ahead of its drilling.

### BACKGROUND OF THE DISCLOSURE

Formation tops are the depths in a well at which formations are found in the subsurface, typically measured in feet or meters below a reference elevation. A formation is a body of rock that is sufficiently distinctive and continuous so that it can be mapped. Formations are the fundamental unit of lithostratigraphy. In stratigraphy, a formation is a body of strata of predominantly one type of rock. Identifying and mapping formations allows geologists to correlate geologic strata across wide distances. Formations serve as geologic time markers based on their relative ages. They are created as a result of the deposition of organic and non-organic materials over a set period of time, usually in millions of years.

Geoscientists traditionally mapped formation tops using geophysical well logs by hand. Geoscientists could then estimate the formation tops for a new well based on individual well log interpretation and well-to-well comparisons. Formations may also be estimated using geological core analysis. More recently, the process of estimating formation tops from well logs has been automated using a variety of warping algorithms that detect similar points in different wells such as the dynamic time warping.

However, such methods of estimating formation tops come with several limitations. Often, well logs are missing from certain wells. When they are available, sometimes certain intervals within the logs are missing. Similarly, core samples are not always available for every well or every interval within a certain well. The manual process of estimating from the well logs is further liable to subjectivity. Lastly, for the newer automated workflows, the methods require a standardized suite of digital well logs, which are not always available in many cases. Other interpolation methods further lack easy application of Delaunay's triangulation approach.

### SUMMARY OF THE DISCLOSURE

Various details of the present disclosure are hereinafter summarized to provide a basic understanding. This summary is not an extensive overview of the disclosure and is neither intended to identify certain elements of the disclosure nor to delineate the scope thereof. Rather, the primary purpose of this summary is to present some concepts of the disclosure in a simplified form prior to the more detailed description that is presented hereinafter.

According to an embodiment consistent with the present disclosure, a method for estimating formation tops for a proposed drilling well includes identifying offset wells of the formation, identifying one or more formation tops each corresponding to a formation depth point for each offset well, performing, in sequence and for each offset well, a grid construction whereby a depth point for the offset well is connected with a depth point of the proposed drilling well, said performing being repeated for each formation top of the offset well, forming a stack of said grids, and estimating a depth of the proposed drilling well for each formation by applying an interpolation method to each said stack.

According to another embodiment, a machine-readable storage medium having stored thereon a computer program for estimating formation tops for a proposed drilling well is disclosed. The computer program includes a routine of set instructions for causing the machine to perform the steps of identifying offset wells of the formation, identifying one or more formation tops each corresponding to a formation depth point for each offset well, performing, in sequence and for each offset well, a grid construction whereby a depth point for the offset well is connected with a depth point of the proposed drilling well, said performing being repeated for each formation top of the offset well, forming a stack of said grids, and estimating a depth of the proposed drilling well for each formation by applying an interpolation method to each said stack

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a flowchart diagram depicting an example of a method for estimating formation tops for a proposed drilling well.

FIG. 2 is a diagram depicting an example of depth points in offset wells corresponding to formations, according to one embodiment.

FIG. 3 is a diagram depicting an example of a stack of polygons corresponding to formations, according to one embodiment.

FIG. 4 depicts an example computing environment that can be used to perform methods according to an aspect of the present disclosure.

FIG. 5 depicts a cloud computing environment that can be used to perform one or more actions according to an aspect of the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments of the present disclosure relate to estimating formation tops for a proposed drilling well, and more specifically, to utilizing a stacked and gridded interpolation method to estimate the formation tops of a proposed well ahead of its drilling.

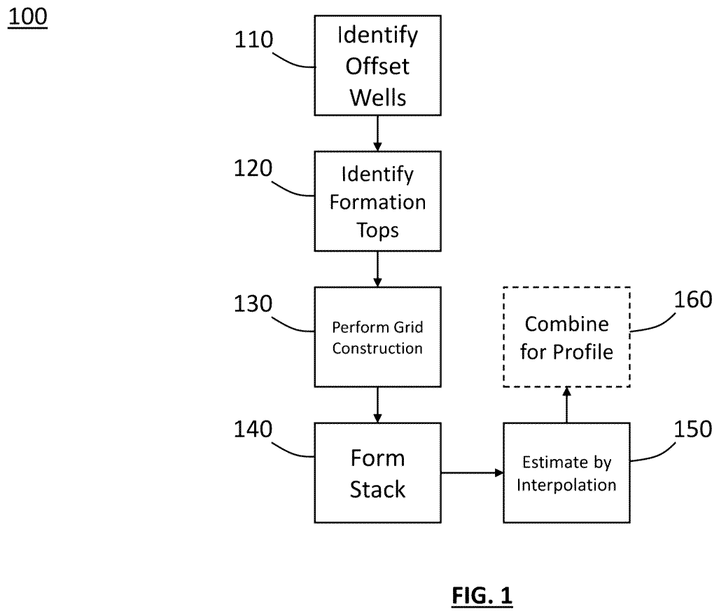

In view of the foregoing structural and functional features described above, an example(s) method will be better appreciated with reference to FIG. 1. While, for purposes of simplicity of explanation, the example method(s) of FIG. 1 is shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the method(s).

FIG. 1 is a flowchart diagram depicting an example of a method 100 for estimating formation tops for a proposed drilling well.

Method 100 comprises identifying offset wells of the formation at step 110, identifying one or more formation tops each corresponding to a formation depth point for each offset well at step 120, performing, in sequence and for each offset well, a grid construction whereby a depth point for the offset well is connected with a depth point of the proposed drilling well, said performing being repeated for each formation top of the offset well at step 130, forming a stack of said grids at step 140, and estimating a depth of the proposed drilling well for each formation by applying an interpolation method to each said stack at step 150.

Offset wells may be any already drilled wells containing known depths for any actual formations encountered within said offset wells. These offset wells may contain any number of actual formations, may come in varying depths, and may come in any number in the area surrounding the location of the new proposed drilling well. In one embodiment, offset wells may be selected within a predetermined radius of the proposed drilling well. For example, in such a predetermined radius of 1000 meters, there may be seven offset wells selected from which the method may use formation top depth points.

A formation top may be any point at any depth within a well at which formations are found in the subsurface. These depths may be measured in feet or meters or any distance metric below a relative elevation. The formations themselves may be any body of rock that is sufficiently distinctive and continuous so that it can be mapped. In stratigraphy, a formation may be a body of strata of predominantly one type of rock. For example, a strata of sandstone may be found in an offset well. This strata of sandstorm may have its formation top located at 32 meters below the surface. Another strata of limestone may be located within this same offset well at 52 meters below the surface, according to an embodiment. They may also consist of a single rock type (lithologies) or of alternating beds of two or more lithologies, or even a heterogeneous mixture of lithologies, so long as they are sufficiently distinguishable from adjacent bodies of rock. Formation tops may also serve as geologic time markers based on their relative ages. They may also may consist of organic and non-organic materials.

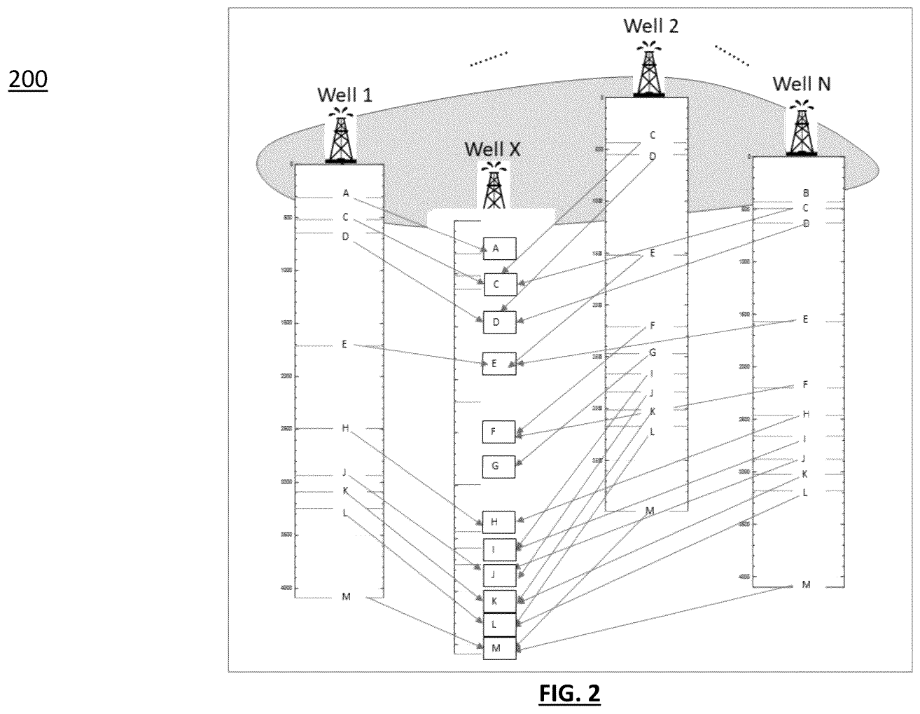

These formation tops may be represented as depth points corresponding to each formation in each offset well. For example, with reference to FIG. 2, there may be offset wells 1, 2, and N containing formation top depth points A-M, according to an embodiment.

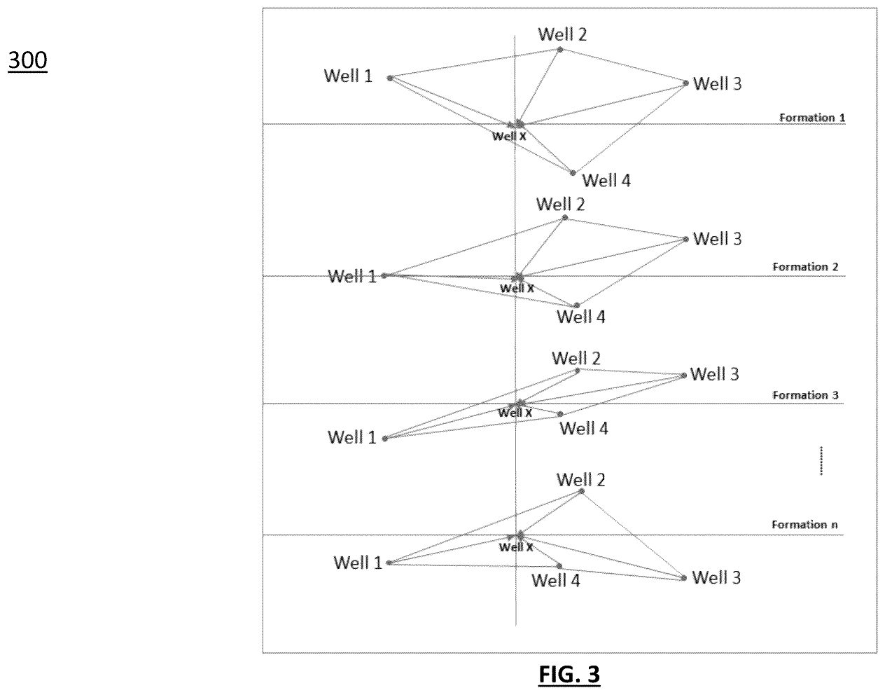

The offset well depth points may then be connected with a depth point of the proposed well, constructing a gridded set of points, forming a polygon. For each formation in the offset wells, a grid is constructed using location details of the offset wells and the depth of the formation to form a polygon where each vertex or edge represents the formation for a well. For example, with reference to FIG. 2, the depth points A-M of the offset wells are connected to corresponding depth points A-M in the proposed drilling well, Well X. This grid construction may be repeated in sequence for each formation top of the offset well. For example, with reference to FIG. 3, the depth points corresponding to Formations 1 are plotted for offset wells 1-4 and their intersections with proposed drilling well, Well X, constructing a gridded set of points, forming a polygon, according to an embodiment. This grid construction may then be reiterated for each formation.

The use of the polygonal approach makes it easier to apply Delauney's triangulation method to the polygon to estimate any certain point within it. In computational geometry, a Delaunay triangulation of a set of points in the plane subdivides their convex hull into triangles whose circumcircles do not contain any of the points. This maximizes the size of the smallest angle in any of the triangles and tends to avoid sliver triangles. A sliver triangle is a triangle with one or two extremely acute angles, providing a long or thin shape, which has undesirable properties during interpolation processes. The Delaunay triangulation is equivalent to the nerve of the cells in a Voronoi diagram, for example, that triangulation of the convex of hull points in the diagram in which every circumcircle of a triangle is an empty circle. Other methods, such as those that are weighted or provide for smoothing effects of curves, may not be as compatible with Delauney's triangulation method. The polygons of the polygonal approach of the present disclosure resemble that of a Voronoi's diagram, making it easier to apply such a triangulation approach.

In one embodiment, the grid construction may also include defining a coordinate system relative to the proposed drilling well and locations of the offset wells. Such a coordinate system may be based any chosen values or metrics, and used for locational purposes within other processes associated with well drilling. In another embodiment, such a coordinate system may be three-dimensional.

The grids of depth points or polygons for each formation may then be stacked, forming a stack of grids. For example, with reference to FIG. 3, the same grid construction is reiterated for Formations 1, 2, 3 . . . n, forming a stack of said polygons representing each of the formations 1 through n. These polygons may be presented in any arrangement, including but not limited to a 2-dimensional stack such as that shown in FIG. 2, or a 3-dimensional model. They may be presented digitally, such as on a mobile device, smartphone, personal laptop computer, personal digital assistant (PDA), desktop computing device, page, or the like, according to some embodiments.

The depth points for each formation in the proposed drilling well may then be estimated by applying an interpolation method to the stack of polygons. An interpolation method may be any process of using known data values to estimate unknown data values. Interpolation methods may have varying degrees of precision. Interpolation methods may also require varying quantities or qualities of data points. For example, one of the simplest interpolation methods, linear interpolation, requires knowledge of two points and the constant rate of change between them. Data points may be obtained by sampling or experimentation. In engineering and science, the data points may represent values of a function for a limited number of values of an independent variable. It is often necessary to interpolate, or estimate, the value of that function for an intermediate value of the independent variable. For example, in the present disclosure, the known depth points of formations within other offset wells may then be interpolated to estimate the depth points for those formations in a proposed drilling well that has yet to begin the drilling process.

In one some embodiments, the interpolation method may be at least one of a linear, cubic, Akima, or spline method.

A linear interpolation method may be a method of curve fitting using linear polynomials to construct new data points within a range of a discrete set of known data points. For example, in an embodiment, the interpolated value at a query point—the proposed well—is based on linear interpolation of the values at neighboring grid points—the edges or vertices of the polygon. In detail, estimating the formation top, y, at point x between two points (x₁, y₁) and (x₂, y₂) may be given as:

$$y = {y}_{1} + \frac{( x - {x}_{1} ) ( {y}_{2} - {y}_{1} )}{{x}_{2} - {x}_{1}}$$

A cubic interpolation method may be a method of interpolation using a third degree polynomial if the values of a function f(x) and its derivative are known at x=0 and x=1, then the function can be interpolated on the interval [0,1]. For example, in an embodiment, the interpolated value at a query point—the proposed well—is based on cubic interpolation of the values at neighboring grid points—the edges or vertices of the polygon. In detail, estimating the formation top, y, at a point x given known points (x₁, y₁) and (x₂, y₂), . . . , (xₙ, yₙ) may be given as:

$$y = {g}_{i} ( x ) = {{a}_{i} ( x - {x}_{i} )}^{3} + {{b}_{i} ( x - {x}_{i} )}^{2} + {c}_{i} ( x - {x}_{i} ) + {d}_{i}$$

A spline interpolation method may be a method of interpolation where the interpolant is a special type of piecewise polynomial called a spline. That is, instead of fitting a single, high-degree polynomial to all of the values at once, spline interpolation fits low-degree polynomials to small subsets of the values, for example, fitting nine cubic polynomials between each of the pairs of ten points, instead of fitting a single degree-nine polynomial to all of them. Spline interpolation methods may be preferred in some embodiments because the interpolation error can be made small even when using low-degree polynomials for the spline. For example, in an embodiment, the interpolated value at a query point—the proposed well—is based on piecewise cubic Hermite interpolation of the values at neighboring grid points—the edges or vertices of the polygon. A cubic Hermite interpolator may be a spline where each piece is a third-degree polynomial specified in Hermite form, that is, by its values and first derivatives at the end points of the corresponding domain interval.

An Akima interpolation method may be a type of non-smoothing spline that gives good fits to curves where the second derivative is rapidly varying. An Akima interpolation may include a higher stability with respect to outlier data points when compared to other spline methods, such as cubic spline. For example, in an embodiment, the interpolated value at a query point—the proposed well—is based on a piecewise function of polynomials with degree at most three evaluated using the values at neighboring grid points—the edges or vertices of the polygon. The Akima formula may be modified to avoid overshoots.

In another embodiment, the interpolation method may be adaptively selected based on a distribution and quality of the depth points within the grid. For example, in an embodiment, a well with known formation tops is considered. Each interpolation method is used to estimate the formation tops of the well. The results of these estimations for each method is then compared to the known formation tops. The method that produces estimate results closest to that of the known formation tops may then be selected as the best for that distribution or quality of depth points. In other embodiments, this selection may be executed automatically or manually, or be iterated any number of times to produce a desired quality.

In another embodiment, the interpolation method may be adaptively selected based on geological characteristics of the formation tops. For example, in an embodiment, a well with known formation tops is considered. Several iterations of each interpolation method may be performed for each rock type, such as carbonate, clastic, dolomite, or shale. The results may then be recorded and compared to the known formation tops for each rock type. The method that produces estimate results closest to that of the known formation tops may then be selected as the best for that particular geological characteristic or rock type. In other embodiments, this selection may be iterated any number of times to produce a desired quality.

In one embodiment, method 100 may further include combining each of the plurality of proposed drilling well depth points to generate a complete formation tops profile for the proposed drilling well at step 160. For example, with reference to FIG. 2, proposed drilling well X could have each of its formation top depth points A-M mapped into a discrete formation tops profile. A profile may include various visual or tactile elements, such as color coding or physical model building or three-dimensional modeling. In one embodiment, a digital and interactive model depicting the complete formation profile of a proposed drilling well may be presented.

In one embodiment, the estimated complete formation tops profile may be used to identify optimal depths for critical drilling points. Such critical drilling points may include but are not limited to points for coring, casing, screening, sampling, and installation of water pumps. In another embodiment, it may be used to prepare for zonal isolation at the critical points in a proposed drilling well. An estimated depth for such critical points allows for more time to prepare, which contributes to saving time and costs on material procurements, transportation, and other well drilling and completion logistics.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

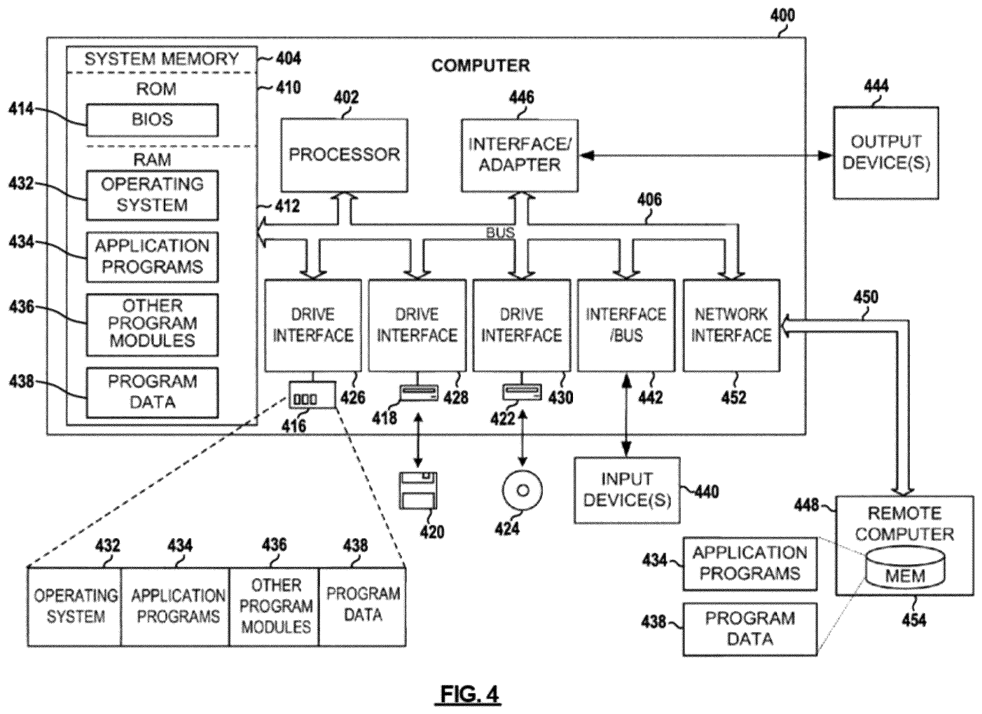

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 4. Thus, reference can be made to one or more examples of FIGS. 1-3 in the example of FIG. 4.

In this regard, FIG. 4 illustrates one example of a computer system 600 that can be employed to execute one or more embodiments of the present disclosure. Computer system 400 can be implemented on one or more general purpose networked computer systems, embedded computer systems, routers, switches, server devices, client devices, various intermediate devices/nodes or standalone computer systems. Additionally, computer system 400 can be implemented on various mobile clients such as, for example, a personal digital assistant (PDA), laptop computer, pager, and the like, provided it includes sufficient processing capabilities.

Computer system 400 includes processing unit 402, system memory 404, and system bus 406 that couples various system components, including the system memory 404, to processing unit 402. Dual microprocessors and other multi-processor architectures also can be used as processing unit 402. System bus 406 may be any of several types of bus structure including a memory bus or memory controller, a peripheral bus, and a local bus using any of a variety of bus architectures. System memory 404 includes read only memory (ROM) 410 and random access memory (RAM) 412. A basic input/output system (BIOS) 414 can reside in ROM 412 containing the basic routines that help to transfer information among elements within computer system 400.

Computer system 400 can include a hard disk drive 416, magnetic disk drive 418, e.g., to read from or write to removable disk 420, and an optical disk drive 422, e.g., for reading CD-ROM disk 424 or to read from or write to other optical media. Hard disk drive 416, magnetic disk drive 418, and optical disk drive 422 are connected to system bus 406 by a hard disk drive interface 426, a magnetic disk drive interface 428, and an optical drive interface 430, respectively. The drives and associated computer-readable media provide nonvolatile storage of data, data structures, and computer-executable instructions for computer system 400. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and disclosed herein. A number of program modules may be stored in drives and RAM 410, including operating system 432, one or more application programs 434, other program modules 436, and program data 438. In some examples, the application programs 434 can include one or more modules (or block diagrams), or systems, as shown and disclosed herein.

A user may enter commands and information into computer system 400 through one or more input devices 440, such as a pointing device (e.g., a mouse, touch screen), keyboard, microphone, joystick, game pad, scanner, and the like. These and other input devices are often connected to processing unit 402 through a corresponding port interface 442 that is coupled to the system bus, but may be connected by other interfaces, such as a parallel port, serial port, or universal serial bus (USB). One or more output devices 444 (e.g., display, a monitor, printer, projector, or other type of displaying device) is also connected to system bus 406 via interface 446, such as a video adapter.

Computer system 400 may operate in a networked environment using logical connections to one or more remote computers, such as remote computer 448. Remote computer 448 may be a workstation, computer system, router, peer device, or other common network node, and typically includes many or all the elements described relative to computer system 400. The logical connections, schematically indicated at 450, can include a local area network (LAN) and a wide area network (WAN). When used in a LAN networking environment, computer system 400 can be connected to the local network through a network interface or adapter 452. When used in a WAN networking environment, computer system 400 can include a modem, or can be connected to a communications server on the LAN. The modem, which may be internal or external, can be connected to system bus 406 via an appropriate port interface. In a networked environment, application programs 434 or program data 438 depicted relative to computer system 400, or portions thereof, may be stored in a remote memory storage device 454.

Although this disclosure includes a detailed description on a computing platform and/or computer, implementation of the teachings recited herein are not limited to only such computing platforms. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models (e.g., software as a service (Saas, platform as a service (PaaS), and/or infrastructure as a service (IaaS)) and at least four deployment models (e.g., private cloud, community cloud, public cloud, and/or hybrid cloud). A cloud computing environment can be service oriented with a focus on statelessness, low coupling, modularity, and semantic interoperability.

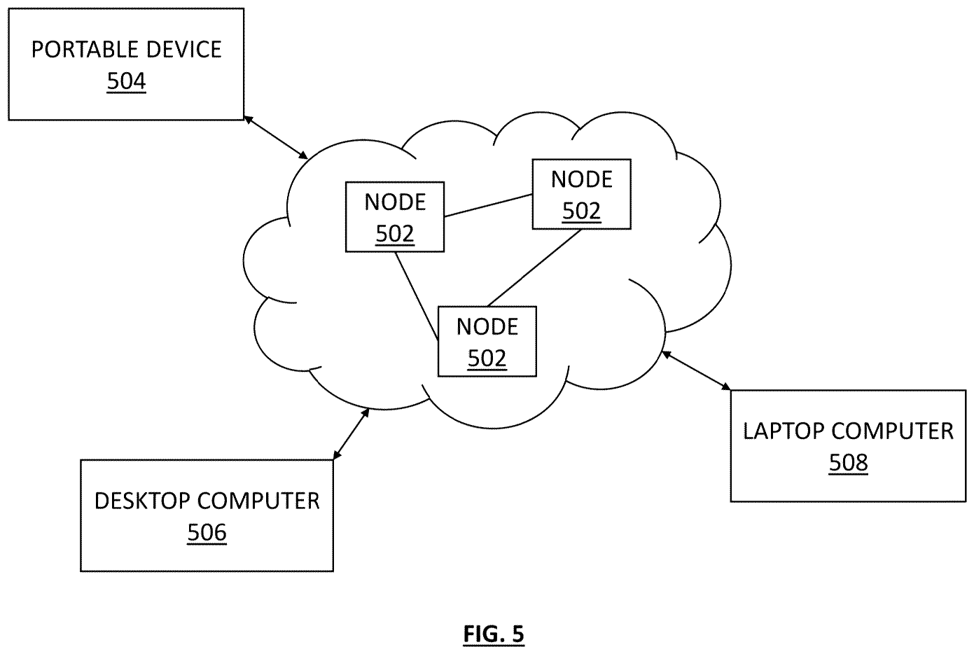

FIG. 5 is an example of a cloud computing environment 500 that can be used for implementing one or more modules and/or systems in accordance with one or more examples, as disclosed herein. Thus, reference can be made to one or more examples of FIGS. 1-4 in the example of FIG. 5. As shown, cloud computing environment 500 can include one or more cloud computing nodes 502 with which local computing devices used by cloud consumers (or users), such as, for example, personal digital assistant (PDA), cellular, or portable device 504, a desktop computer 506, and/or a laptop computer 508, may communicate. The computing nodes 502 can communicate with one another. In some examples, the computing nodes 502 can be grouped (not shown) physically or virtually, in one or more networks, such as Private, Community, Public, or Hybrid clouds, or a combination thereof. This allows the cloud computing environment 500 to offer infrastructure, platforms and/or software as services for which a cloud consumer does not need to maintain resources on a local computing device. The devices 504-508, as shown in FIG. 5, are intended to be illustrative and that computing nodes 502 and cloud computing environment 500 can communicate with any type of computerized device over any type of network and/or network addressable connection (e.g., using a web browser). In some examples, the one or more computing nodes 502 are used for implementing one or more examples disclosed herein relating to root-source identification. Thus, in some examples, the one or more computing nodes can be used to implement modules, platforms, and/or systems, as disclosed herein.

In some examples, the cloud computing environment 500 can provide one or more functional abstraction layers. It is to be understood that the cloud computing environment 500 need not provide all of the one or more functional abstraction layers (and corresponding functions and/or components), as disclosed herein. For example, the cloud computing environment 500 can provide a hardware and software layer that can include hardware and software components. Examples of hardware components include: mainframes; RISC (Reduced Instruction Set Computer) architecture based servers; servers; blade servers; storage devices; and networks and networking components. In some embodiments, software components include network application server software and database software.

In some examples, the cloud computing environment 500 can provide a virtualization layer that provides an abstraction layer from which the following examples of virtual entities may be provided: virtual servers; virtual storage; virtual networks, including virtual private networks; virtual applications and operating systems; and virtual clients. In some examples, the cloud computing environment 500 can provide a management layer that can provide the functions described below. For example, the management layer can provide resource provisioning that can provide dynamic procurement of computing resources and other resources that are utilized to perform tasks within the cloud computing environment. The management layer can also provide metering and pricing to provide cost tracking as resources are utilized within the cloud computing environment 500, and billing or invoicing for consumption of these resources. In one example, these resources may include application software licenses. Security provides identity verification for cloud consumers and tasks, as well as protection for data and other resources. The management layer can also provide a user portal that provides access to the cloud computing environment 500 for consumers and system administrators. The management layer can also provide service level management, which can provide cloud computing resource allocation and management such that required service levels are met. Service Level Agreement (SLA) planning and fulfillment can also be provided to provide pre-arrangement for, and procurement of, cloud computing resources for which a future requirement is anticipated in accordance with an SLA.

In some examples, the cloud computing environment 500 can provide a workloads layer that provides examples of functionality for which the cloud computing environment 500 may be utilized. Examples of workloads and functions which may be provided from this layer include: mapping and navigation; software development and lifecycle management; virtual classroom education delivery; data analytics processing; and transaction processing. Various embodiments of the present disclosure can utilize the cloud computing environment 500.

The present disclosure is also directed to the following exemplary embodiments, which can be practiced in any combination thereof:
Embodiment 1: A combination of claims 1-10.
Embodiment 2: A combination of claims 11-20.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a standalone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware based systems that perform the specified functions or acts or carry out combinations of special purpose hardware and computer instructions.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof. In addition, the use of ordinal numbers (e.g., first, second, third, etc.) is for distinction and not counting. For example, the use of “third” does not imply there must be a corresponding “first” or “second.” Also, as used herein, the terms “coupled” or “coupled to” or “connected” or “connected to” or “attached” or “attached to” may indicate establishing either a direct or indirect connection, and is not limited to either unless expressly referenced as such. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The term “based on” means “based at least in part on.” The terms “about” and “approximately” can be used to include any numerical value that can vary without changing the basic function of that value. When used with a range, “about” and “approximately” also disclose the range defined by the absolute values of the two endpoints, e.g. “about 2 to about 4” also discloses the range “from 2 to 4.” Generally, the terms “about” and “approximately” may refer to plus or minus 5-10% of the indicated number.

What has been described above include mere examples of systems, computer program products and computer-implemented methods. It is, of course, not possible to describe every conceivable combination of components, products and/or computer-implemented methods for purposes of describing this disclosure, but one of ordinary skill in the art can recognize that many further combinations and permutations of this disclosure are possible. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

The invention claimed is:

1. A method for estimating formation tops for a proposed drilling well, the method comprising:
identifying offset wells of the formation;
identifying one or more formation tops each corresponding to a formation depth point for each offset well;
performing, in sequence and for each offset well, a grid construction whereby a depth point for the offset well is connected with a depth point of the proposed drilling well, said performing being repeated for each formation top of the offset well;
forming a stack of said grids; and
estimating a depth of the proposed drilling well for each formation by applying an interpolation method to said stack.

2. The method of claim 1 further comprising combining each of the plurality of proposed drilling well depth points to generate a complete formation tops profile for the proposed drilling well.

3. The method of claim 1 wherein the interpolation method comprises at least one of a linear, cubic, Akima, or spline method.

4. The method of claim 1 wherein the interpolation method is adaptively selected based on a distribution and quality of the depth points within the grid.

5. The method of claim 1 wherein the interpolation method is adaptively selected based on geological characteristics of the formation tops.

6. The method of claim 1 wherein identifying offset wells comprises selecting offset wells within a predetermined radius of the proposed drilling well.

7. The method of claim 1 wherein performing a grid construction further comprises defining a coordinate system relative to the proposed drilling well and locations of the offset wells.

8. The method of claim 7 wherein the coordinate system is three-dimensional.

9. The method of claim 2 wherein the estimated complete formation tops profile is used to identify optimal depths for critical drilling points.

10. The method of claim 9 wherein the critical drilling points comprise points for coring, casing, screening, sampling, and installation of water pumps.

11. A computer-readable storage medium containing instructions for estimating formation tops for a proposed drilling well, wherein the instructions, when executed by a processor, cause the processor to perform operations comprising:
identifying offset wells of the formation;
identifying one or more formation tops each corresponding to a formation depth point for each offset well;
performing, in sequence and for each offset well, a grid construction whereby a depth point for the offset well is connected with a depth point of the proposed drilling well, said performing being repeated for each formation top of the offset well;
forming a stack of said grids; and
estimating a depth of the proposed drilling well for each formation by applying an interpolation method to said stack.

12. The computer-readable storage medium of claim 11, the set of instructions further causing the machine to perform the steps of combining each of the plurality of proposed drilling well depth points to generate a complete formation tops profile for the proposed drilling well.

13. The computer-readable storage medium of claim 11 wherein the interpolation method comprises at least one of a linear, cubic, Akima, or spline method.

14. The computer-readable storage medium of claim 11 wherein the interpolation method is adaptively selected based on a distribution and quality of the depth points within the grid.

15. The computer-readable storage medium of claim 11 wherein the interpolation method is adaptively selected based on geological characteristics of the formation tops.

16. The computer-readable storage medium of claim 11 wherein identifying offset wells comprises selecting offset wells within a predetermined radius of the proposed drilling well.

17. The computer-readable storage medium of claim 11 wherein performing a grid construction further comprises defining a coordinate system relative to the proposed drilling well and locations of the offset wells.

18. The computer-readable storage medium of claim 17 wherein the coordinate system is three-dimensional.

19. The computer-readable storage medium of claim 12 wherein the estimated complete formation tops profile is used to identify optimal depths for critical drilling points.

20. The computer-readable storage medium of claim 19 wherein the critical drilling points comprise points for coring, casing, screening, sampling, and installation of water pumps.
